(19) United States
(12) Patent Application Publication
(10) Pub. No.: US 2012/0262160 A1
(43) Pub. Date: Oct. 18, 2012

(54) ASYMMETRIC VARIABLE RELUCTANCE (VR) TARGET FOR MULTI-DIMENSIONAL MONITORING

(75) Inventor: Joseph William Michalski, JR., Valley View, OH (US)

(73) Assignee: Rolls-Royce Corporation, Indianapolis, IN (US)

(21) Appl. No.: 13/088,008

(22) Filed: Apr. 15, 2011

(51) Int. Cl. G01B 7/30

(52) U.S. Cl. 324/207.25

(57) ABSTRACT

A system is provided for dynamically determining an axial position of a rotating member. The system includes a target component on a circumferential periphery of the rotating member, the target component having a longitudinally asymmetric shape. The system further includes a sensor assembly fixedly positioned relative to the target component. The sensor assembly detects and outputs a plurality of signals having different positive pulse widths, as the target component moves axially past the sensor. The system further includes a circuit coupled to the sensor assembly and receiving the plurality of signals. The circuit determines an axial position of the target component for each of the plurality of signals based on a comparison of the different positive pulse widths.

### ACKNOWLEDGEMENT OF FEDERAL RESEARCH SUPPORT

This invention was made with government support under Contract No. N00019-02-C-3003 awarded by the United States Department of Defense. The government has certain rights in the invention.

### TECHNICAL FIELD

This invention generally relates to systems and methods for monitoring rotating components, and more particularly relates to a system and method for monitoring axial and angular positions of a rotating component using an asymmetric variable reluctance target.

### BACKGROUND OF THE INVENTION

Reluctance is defined as the ability of a material to pass a magnetic field, and is typically likened to resistance in an electric circuit. A variable reluctance sensor, used to measure rotational position and speed of rotating metal components or targets, typically includes a permanent magnet and a pickup coil. The variable reluctance (VR) sensor is generally located adjacent and in close proximity to a rotating component, such as a gear or rotor, which typically has a plurality of circumferentially interspaced slots and teeth formed therein. As the component rotates relative to the VR sensor, an alternating signal is magnetically generated in the VR sensor when the teeth on the component travel past the VR sensor. The alternating signal can then be decoded to recognize periodic voltage levels. The frequency of the alternating periodic voltage is then determined to obtain rotational information about the component, such as speed and direction.

As shown in FIG. 1, a conventional VR measurement system 100 includes a sensor assembly 102 situated in proximity to a rotating shaft 104 having at an axial position a VR target 106. The sensor assembly 102 includes a permanent magnet 103 surrounded by a pickup wire coil 105, and is coupled to a monitoring unit 109, which includes a processor unit and a memory unit. The VR target 106 includes a plurality of axially oriented pairs of slots 108 and teeth 110, formed circumferentially on the shaft 104. Each of the slots 108 includes substantially parallel walls along the axial length of the shaft 104, thereby defining a longitudinally symmetric VR target 106 aligned parallel to the axis of rotation of the shaft 104. As the VR target 106 rotates past the sensor assembly 102, an alternating signal having a sinusoidal waveform is magnetically generated and detected by the sensor assembly 102. The generated signal serves to measure and monitor rotational attributes of the shaft 104. Due to the symmetric VR target 106, an axial displacement of the VR target 106, having a constant rotational speed, relative to the sensor assembly 102 within an axial band or range defined by the slots 108 and teeth 110 still results in the generation of the same sinusoidal signal waveform 212, as shown in FIG. 2.

Thus, by utilizing symmetric VR targets, conventional VR measurement systems are limited to determining only rotational attributes of rotating components, but not their axial displacements relative to the associated sensors. Therefore, there exists a need for a system and method for dynamically monitoring axial positions or displacements of a rotating component relative to a fixedly positioned magnetic sensor assembly.

### SUMMARY OF THE INVENTION

The invention is defined by the appended claims. This description summarizes some aspects of the present embodiments and should not be used to limit the claims. The foregoing problems are solved and a technical advance is achieved by a system, method, and articles of manufacture consistent with the invention, which dynamically monitor axial and angular positions of a rotating component using an asymmetric variable reluctance target.

One embodiment of the invention is directed to a system is provided for dynamically determining an axial position of a rotating member. The system includes a target component on a circumferential periphery of the rotating member, the target component having a longitudinally asymmetric shape. The system further includes a sensor assembly fixedly positioned relative to the target component. The sensor assembly detects and outputs a plurality of signals having different positive and/or negative pulse widths or combination of both, as the target component moves axially past the sensor. The system further includes a circuit coupled to the sensor assembly and receiving the plurality of signals. The circuit determines an axial position of the target component for each of the plurality of signals based on a comparison of the different positive pulse widths.

In another embodiment, the target component has a magnetic conducting property, and the sensor assembly has a magnetic unit and a magnetic flux detecting unit. The target has includes a plurality of circumferentially interspaced slots and teeth, each of the slots having substantially non-parallel longitudinal walls.

In a further embodiment, the target component is a longitudinally asymmetric optical target and the sensor assembly includes optical detectors.

Other systems, methods, articles of manufacture, features, and advantages of the invention will be, or will become, apparent to one having ordinary skill in the art upon examination of the following drawings and detailed description. It is intended that all such additional articles of manufacture, features, and advantages included within this description, be within the scope of the invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the invention. In the drawings, like reference numerals designate corresponding parts throughout the several views.

FIG. 1 is a schematic diagram illustrating an embodiment of a prior art system for dynamically monitoring rotational positions and speed of a rotating component using a symmetric variable reluctance target;

FIG. 2 is a graph illustrating a waveform representative of a voltage generated by the rotating component of FIG. 1;

FIG. 3A is a schematic diagram illustrating an embodiment of a system for dynamically monitoring axial positions of a rotating component using an asymmetric variable reluctance target;

FIG. 3B is a perspective view of the sensor assembly of FIG. 3A;

FIG. 4 is a graph illustrating a plurality of waveforms representative of signals generated by the rotating component of FIG. 3A;

FIG. 5 is a flow diagram illustrating an embodiment of a process for determining an axial position or displacement of the rotating component relative to the sensor assembly of FIG. 3A;

FIGS. 6A-6B are schematic diagrams illustrating an embodiment of a system for dynamically monitoring axial and radial positions of a rotating component using an asymmetric variable reluctance target;

FIG. 6C is a perspective view of one of the sensor assemblies of FIGS. 6A and 6B;

FIG. 7 is a graph illustrating a plurality of waveforms representative of signals generated by the rotating component of FIGS. 6A-6B; and

FIG. 8 is a flow diagram illustrating a method for dynamically monitoring axial and radial positions of a rotating component using an asymmetric variable reluctance target.

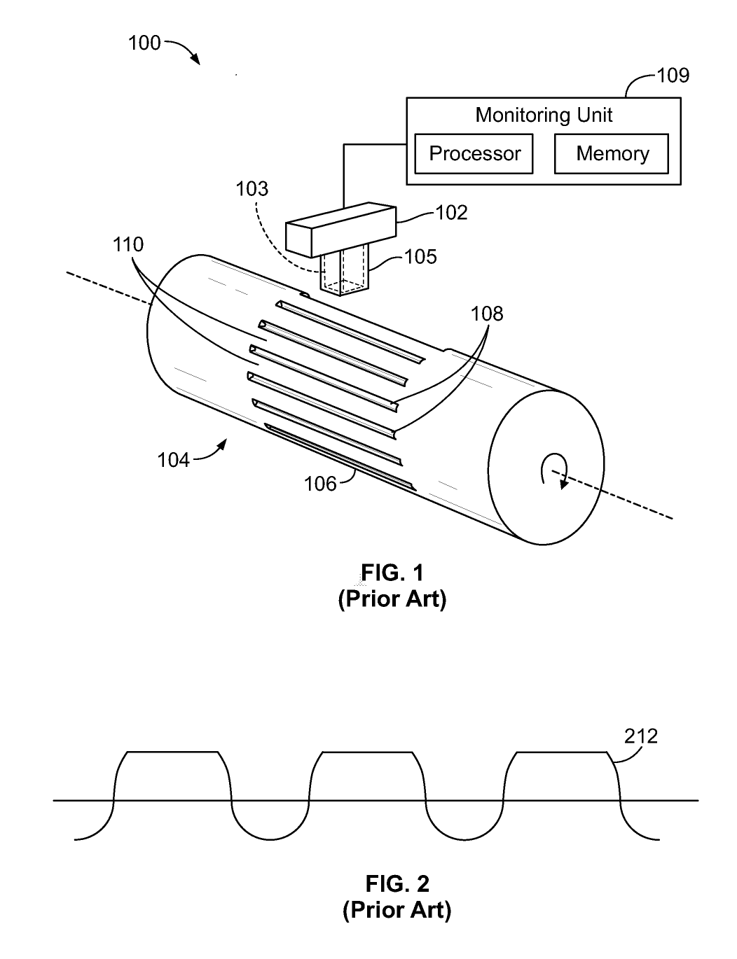

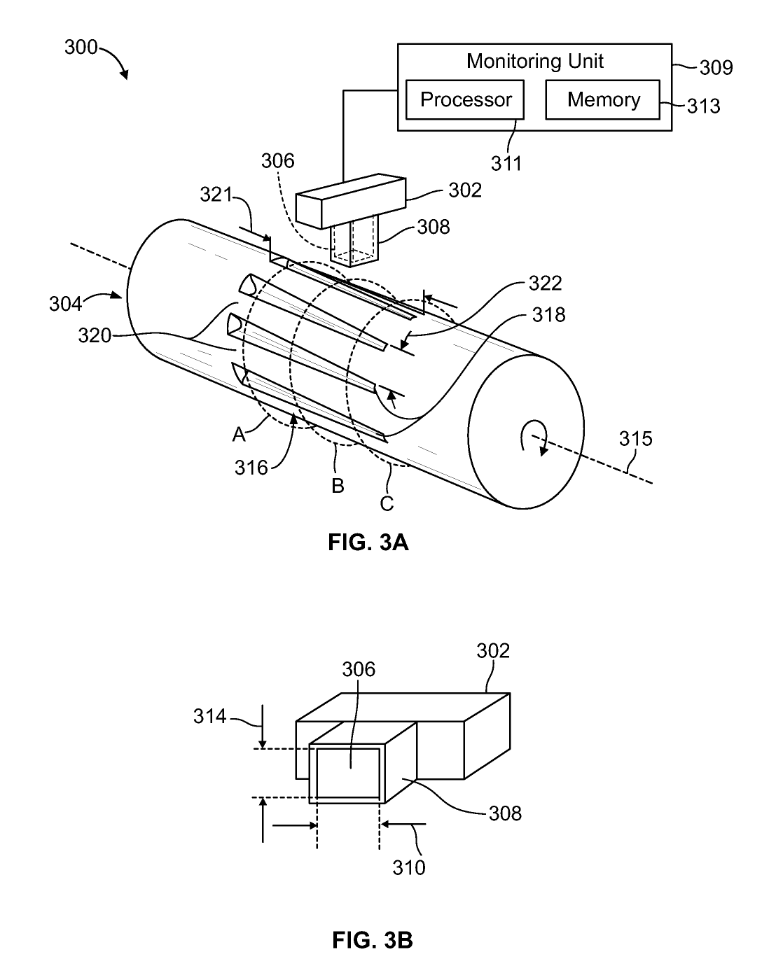

Illustrative and exemplary embodiments of the invention are described in further detail below with reference to and in conjunction with the figures.

### DETAILED DESCRIPTION OF THE DRAWINGS

The invention is defined by the appended claims. This description summarizes some aspects of the present embodiments and should not be used to limit the claims.

While the invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

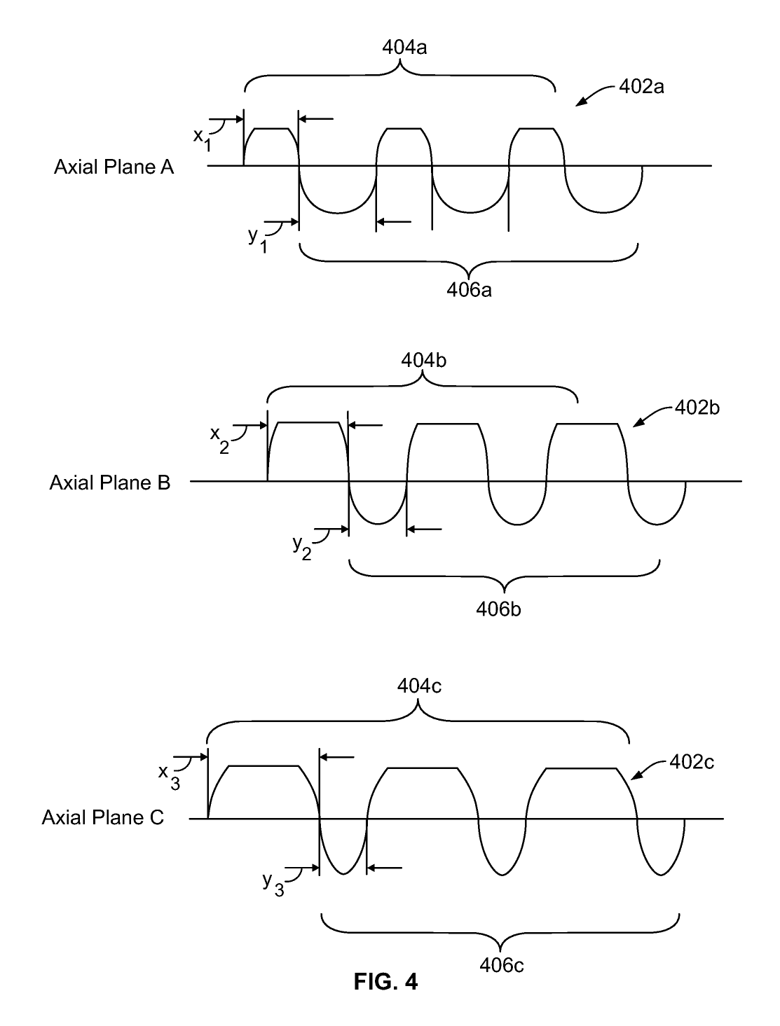

Now referring to FIGS. 3A-3B, an embodiment of a system 300 for dynamically monitoring axial positions of a rotating component using an asymmetric variable reluctance target is shown. The system 300 includes a sensor assembly 302, a rotating component 304, such as a shaft, which includes a metallic VR target 316, and a monitoring logic circuit or unit 309 coupled to the sensor assembly 302. As shown, the sensor assembly 302 includes a permanent magnet 306 surrounded by a pickup wire coil 308, and the monitoring unit 309 captures and processes signals generated in the coil 308 from the movement of the rotating VR target 316. Alternatively, any other suitable magnetic field sensor assembly 302 can be used, and the monitoring unit 309 may also be integral to the sensor assembly 302. In the embodiment shown of FIG. 3A, the monitoring unit 309 includes a processing unit 311 and a memory unit 313.

The rotating VR target 316 includes a plurality of circumferentially distributed slots 318, alternately separated by circumferentially distributed teeth 320. The slots 318 are aligned substantially parallel to the axis of rotation 315 of the component 304 and each slot 318 includes non-parallel longitudinal walls when viewed with respect to one another. As such, from one axial end to the other axial end, slots 318 become progressively narrower circumferentially as the adjacent teeth 320 become wider circumferentially, thereby rendering the VR target 316 longitudinally or axially asymmetric. It is to be understood that each of the expressions “longitudinally asymmetric” and “axially asymmetric” is intended to refer to a component or article which is not symmetrical with respect to a plane transverse or normal to the longitudinal axis of the component or article. In other words, by reason of the geometrical changes, i.e., narrowing and widening and vice versa, that both the slots 318 and the teeth 320 incur longitudinally, the VR target 316 may be defined as being longitudinally or axially asymmetric about a plane transverse or normal to its longitudinal axis.

In one embodiment, a slot pitch 322, which is the sum of a circumferential length of one slot 318 and a circumferential length of one adjacent tooth 320, remains substantially constant at each longitudinal position along the axial length of the VR target 316. Each of the slots 318 has an axial length 321, that is greater than a length 310 of the permanent magnet 306, as measured longitudinally along the axis of rotation of the component 304. Preferably, the slot pitch 322 is greater than a width 314 of the permanent magnet 306, measured perpendicularly to the axis of rotation of the VR target 316. The sensor assembly 302 is fixedly positioned in radial proximity to the VR target 316, while the rotating component 304 moves axially fore and aft relative to the sensor assembly 302.

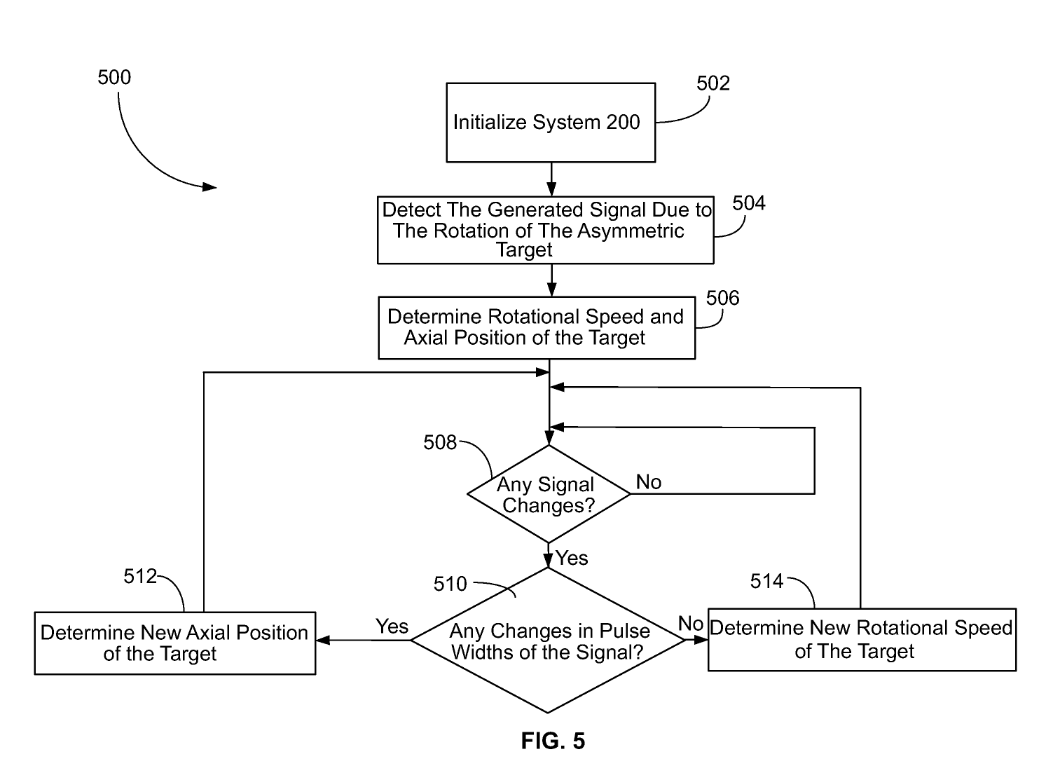

Now referring to FIGS. 3A-3B and 4, as the VR target 316 rotates and the slots 318 and the teeth 320 move past the fixed sensor assembly 302, the sensor assembly 302 detects a modulating magnetic flux and generates a corresponding alternating signal having a generally sinusoidal waveform. The generated sinusoidal signal has a frequency being representative of the rotational speed of the VR target 316. Based on the above-discussed longitudinally asymmetric configuration of the VR target 316, the waveform of the generated sinusoidal signal varies based on the axial position of the VR target 316 relative to that of the sensor assembly 302. As shown in FIG. 3A, when the sensor assembly 302 is positioned axially at approximately axial plane A, where the circumferential length of the teeth 320 is relatively smaller than the circumferential length of the slots 318, the generated signal 402a of FIG. 4 is a waveform which includes positive signal parts 404a, corresponding to teeth 320, that have a pulse width X1 that is narrower than a pulse width Y1 of the negative signal parts 406a, corresponding to slots 318. When the sensor assembly 302 is positioned axially at approximately axial plane B, where the circumferential length of the teeth 320 is substantially equal to that of the slots 318, the generated signal 402b includes positive signal parts 404b having a pulse width X2 that is substantially equal to a pulse width Y2 of the negative signal parts 406b. When the sensor assembly 302 is positioned axially at approximately axial plane C, where the circumferential length of the teeth 320 is greater than that of the slots 318, the generated signal 402c includes positive signal parts 404c having a pulse width X3 that is greater than a pulse width Y3 of the negative signal parts 406c. As such, the pulse widths X1, X2, X3 of the positive signal parts 404a, 404b, and 404c of generated signals 402a, 402b, and 402c, respectively, increase as the teeth 320 get increasingly longer circumferentially. Likewise, the pulse widths Y1, Y2, Y3 of the negative signal parts 406a, 406b, and 406c of generated signals 402a, 402b and 402c, respectively, decrease as the teeth 320 get increasingly shorter circumferentially. Thus, monitoring unit 309 may monitor the axial displacements of rotating component 304 relative to the fixed axial position of sensor assembly 302 by comparing the generated signals, such as 402a, 402b, and 402c, to known or predicted output signals corresponding to the known longitudinal characteristics of the VR target 316.

To calibrate and configure monitoring unit 309 for detecting and determining the axial positions of the rotating component 304 relative to the sensor assembly 302 for each of a plurality of rotational speeds of the component 304, the position of the VR target 316 is gradually axially moved relative to the sensor assembly 302 to generate and store a signal having gradually varying pulse widths, as illustrated by signals 402a-402c, in the memory unit 313 of the monitoring unit 309. Alternatively, the rotating VR target 316 may be positioned at a plurality of known axial positions relative to the fixed position of the sensor assembly 302, and the corresponding generated signals are used for comparison with a signal generated during operation to determine by interpolation and/or extrapolation an axial position of the VR target 316 relative to the sensor assembly 302 corresponding to the generated signal. Accordingly, during operation of a machine or device which includes the system 300, as the VR target 316 moves axially past the sensor assembly 302, the signal generated maintains a frequency that corresponds to the rotational speed of the VR target 316 but its pulse widths varies with the target axial displacement. Based on the stored signals, the monitoring unit 309 can correlate each of the varying pulse widths of the signals 402a-402c to specific axial positions of the rotating VR target 316 relative to the sensor assembly 302. As such, the sensor assembly 302 in tandem with the monitoring unit 309 can help determine axial positions and displacements of the VR target 316, and thus the rotating component 304, relative to the sensor assembly 302.

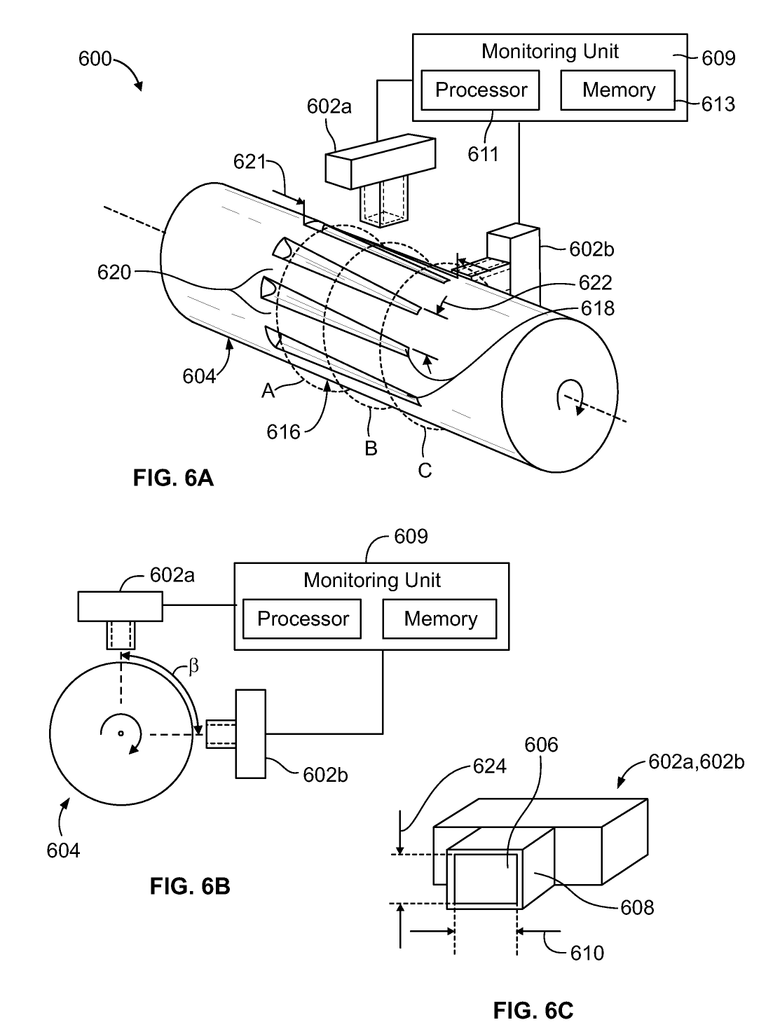

Now referring to FIG. 5, a flow diagram illustrates a method 500 for dynamically monitoring the axial position of the VR target 316 by the system 300. Upon initialization of the system 300, at Step 502, as the VR target 316 of rotating component 304 rotates, and the slots 318 and teeth 320 alternatingly move past the sensor assembly 302, the generated signal is dynamically captured by the sensor assembly 302, and then compared by the monitoring unit 309 to the plurality of stored generated signals, at Step 504. Utilizing the frequency and the positive pulse width X or negative pulse width Y of the generated signal in the signal comparison, the monitoring unit 309 determines the rotational speed and axial position of the VR target 316 relative to the sensor assembly 302, at Step 506. Hereafter, for the sake of simplicity, only the positive pulse width X will be utilized in the analysis of the generated signals. While the VR target 316 continues to rotate, the monitoring unit 309 continues to monitor the generated signal for any changes in its frequency and/or positive pulse widths X, at Step 508. In the event that the positive pulse width X is determined to have changed, at Step 510, the current value of the positive pulse width X is utilized to determine the current axial position of the VR target 316 relative to the sensor assembly 302 by comparing this value of the positive pulse width X to those of the plurality of stored generated signals, at Step 512. In case the frequency is determined to have changed, rather than the positive pulse width X, the current frequency is used to determine the new rotational speed of the VR target 316, at Step 514, by comparing it to the signal frequencies associated with the plurality of rotational speeds of the component 304. Alternately, in case both the frequency and the positive pulse width X are determined to have changed simultaneously, the current positive pulse width X and the frequency are used to determine the current rotational speed and the current axial position of the VR target 316.

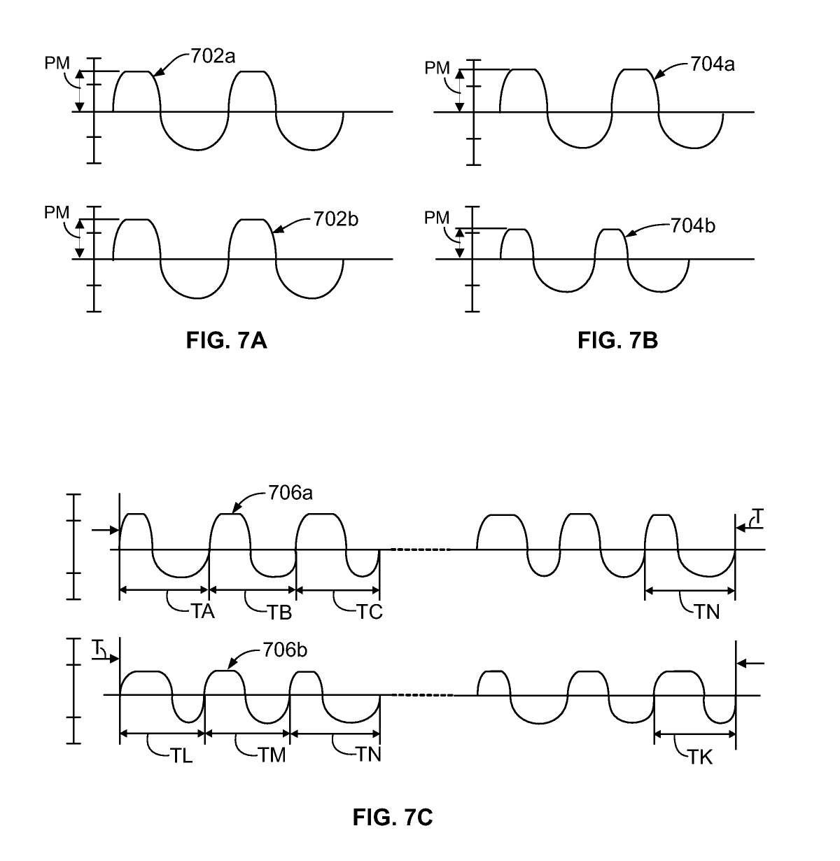

Now referring to FIGS. 6A and 6B, there is illustrated an embodiment of a system 600 for dynamically monitoring axial and radial positions of a rotating component 604. The system 600 includes a pair of sensor assemblies 602a and 602b, rotating component 604, such as a shaft, which includes a metallic portion or VR target 616, and a monitoring logic circuit or unit 609 coupled to the pair of sensor assemblies 602a and 602b. The monitoring unit 609 includes a processing unit 611 and a memory unit 613. As shown, each of the pair of sensor assemblies 602a and 602b includes a permanent magnet 606 surrounded by a pickup wire coil 608, and the monitoring unit 609 captures and analyzes signals generated in the pair of coils 608 from the movement of the rotating VR target 616. Alternatively, any other suitable magnetic field sensor assemblies can be used.

In one embodiment, the sensor assemblies 602a and 602b are positioned at approximately ninety degree (90) angle from each other with respect to the axis of rotation of the VR target 616, and fixedly positioned in radial proximity to the VR target 616. In another embodiment, the pair of sensor assemblies 602a and 602b may be separated by any other angle β. Moreover, the sensor assemblies 602a and 602b are positioned at the same axial position relative to the VR target 616 and at an equal radial distance from the VR target 616. As such, the air gaps separating each of the pair of sensor assemblies 602a and 602b and the VR target 616 are substantially identical. In another embodiment, the sensor assemblies 602a and 602b may be positioned at different axial positions and/or at different radial distances from the VR target 616. In yet another embodiment, three sensor assemblies may be positioned 120 degrees apart from one another. Alternatively, any number “S” of sensor assemblies may be utilized, with “S” being an integer equal or greater than 2. The “S” number of sensor assemblies may be positioned approximately equidistant from one another at an angle “β” equal to 360 divided by the integer number “S”, or may be positioned at varying angles with respect to one another around rotating component 604. The “S” number of sensor assemblies may be fixedly positioned at different axial positions relative to one another along VR target 616 and/or at different radial distances from the VR target 616.

As shown in the embodiment of FIGS. 6A-6C, the VR target 616 is similar to the VR target 316, discussed above. Like VR target 316, the rotating VR target 616 includes a plurality of circumferential slots 618, alternately separated by teeth 620, both of which are geometrically similar to those of the VR target 316. Similarly, the sensor assemblies 602 are similar to the sensor assembly 302, discussed above. Like sensor assembly 302, an axial length 621 of each of the slots 618 is greater than a length 610 of each of the pair of permanent magnets 606, measured along an axis parallel to the axis of rotation of the component 602, and the pitch 622 is greater than a width 624 of each of the pair of permanent magnets 606.

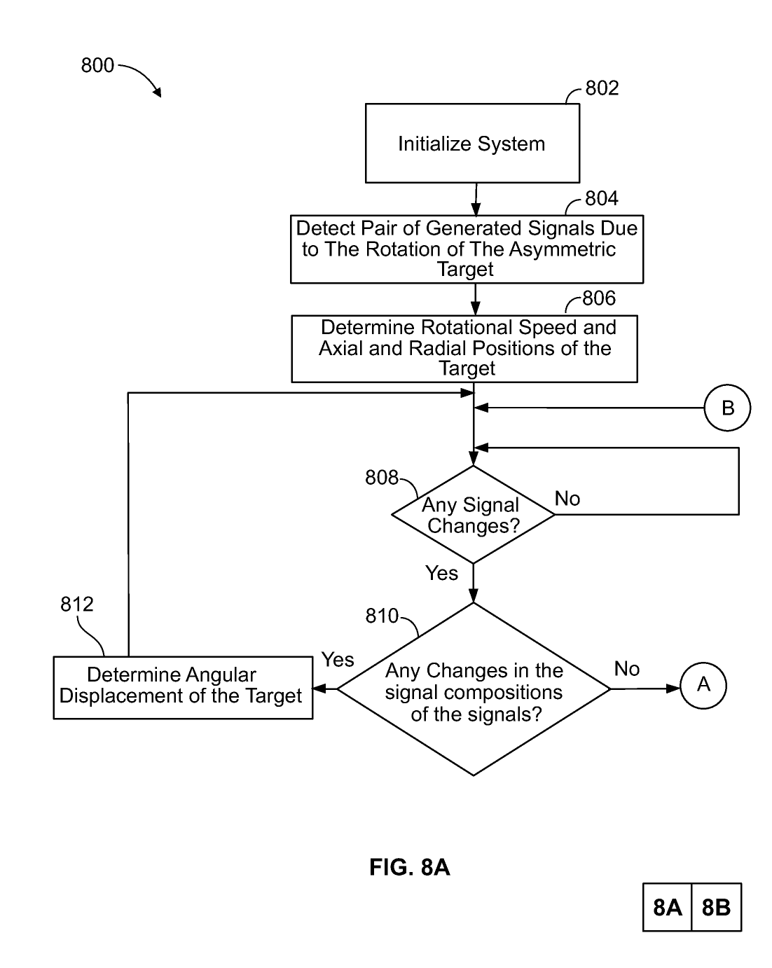

Now referring to FIG. 7A, during operation of system 600, if the VR target 616, while rotating, moves purely axially past the pair of sensor assemblies 602a and 602b, the generated pair of signals 702a and 702b remain substantially identical to each other. That is, they maintain a substantially identical frequency, which corresponds to the rotational speed of the VR target 616, substantially identical varying pulse widths, and substantially identical pulse magnitudes PM during the axial displacement. As such, in this scenario only one of the signals 702a and 702b is needed to determine the axial positions of VR the target 616 relative to the sensor assemblies 602a and 602b.

As shown in FIG. 7B, if the VR target 616, while rotating at a constant speed, is displaced radially relative to the pair of sensor assemblies 602a and 602b, then the pulse magnitudes PM of each of the respective generated signals 704a and 704b vary, but not necessarily in the same manner. Based on the fact that a generated magnetic flux by a permanent magnet in a flux conducting target, such as VR target 616, increases as the air gap separating them decreases and vice versa, the monitoring unit 609 can be configured to determine whether the air gaps separating the VR target 616 from the sensor assemblies 602a or 602b, respectively, is increasing or decreasing based on the changes incurred by their respective pulse magnitudes PM, thereby determining the radial displacement of the VR target 616 relative to each of the sensor assemblies 602a and 602b.

As shown in FIG. 7C, when the axis of rotation of the VR target 616 is tilted or angled away from its original direction, as may occur when, for example, the rotating component 604 is under a radial or side load, the pulse magnitude PM of the generated signal 706a or 706b may decrease or increase based on whether the corresponding airgap between sensor assemblies 602a or 602b and VR target 616 has increased or decreased. Moreover, with N being the total number of pairs of slots 618 and teeth 620 formed circumferentially on the VR target 616, this angular displacement of the VR target 616 causes each of the generated signals 706a and 706b to become a sequence of N of different waveforms 702a-702N having the same pulse magnitude PM but different periods TA-TN, each associated with one of the N different waveforms. As such, each of the signals 706a and 706b may not have a uniform waveform over a period T, which is equal to the sum of the periods TA through TN, and may be different with respect to one another. By processing the changes of the pulse magnitude PM and the signal composition of each of the signal 706a and 706b, the monitoring unit 609 can determine at least axial and angular displacements, and rotational speed of the VR target 616, and thus rotating component 604, relative to the pair of sensor assemblies 602a and 602b.

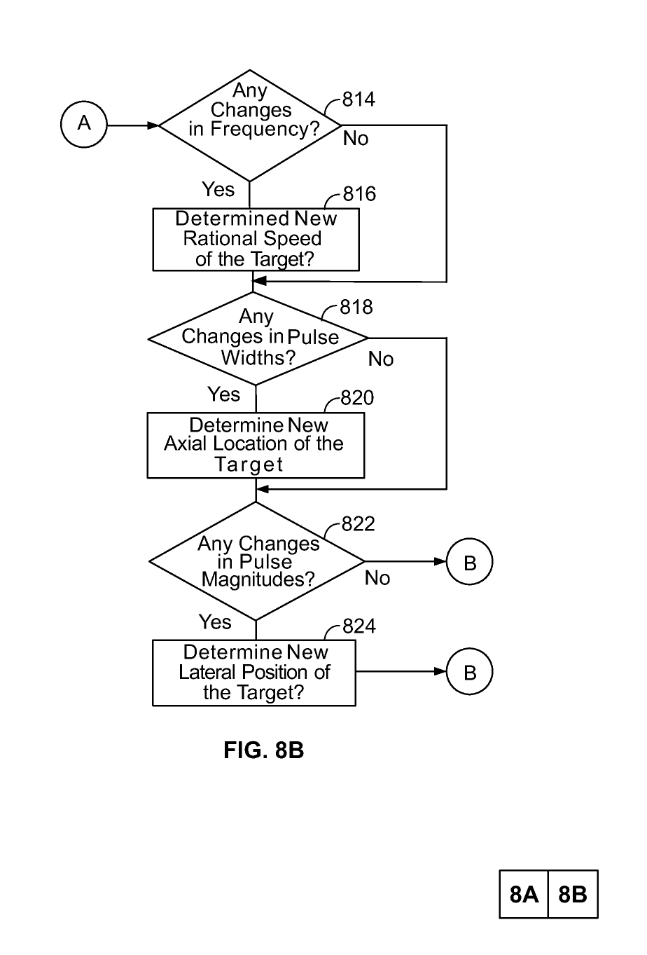

Now referring to FIG. 8, there is illustrated a method 800 for dynamically monitoring the axial and angular displacements of the VR target 616 by the system 600. Upon initialization of the system 600, at Step 802, as the VR target 616 rotates, and the slots 618 and teeth 620 alternately move past the pair of sensor assemblies 602a and 602b, the corresponding pair of generated signals is captured by the pair of sensor assemblies 602a and 602b, respectively, at Step 804. By continuously monitoring changes in the attributes, such as frequency, positive and negative pulse widths, pulse magnitude, and signal composition, of these generated signals, the system 600 can dynamically determine any gradual or discrete axial and angular displacements of the VR target 616 relative to the pair of sensor assemblies 602a and 602b. For the sake of simplicity of description, the rotating component 604 is assumed to have initially a vertical axis of rotation. At Step 806, after capturing and processing the generated signals, the monitoring unit 606 determines the initial rotational speed, and axial and lateral positions of the VR target 616 relative to the sensor assemblies 602a and 602b. Subsequently during the monitoring process, upon detection of any changes in the generated signals, at Step 808, the monitoring unit 606 determines which of the signal attributes incurred any changes.

Still referring to FIG. 8, upon detection of any changes in the generated pair of signals, the monitoring unit 609 determines whether their signal compositions have changed, at Step 810. If in the affirmative, the current pulse magnitudes and signal periods are determined, at Step 812, to establish the new angular, radial and axial positions. Otherwise, the monitoring unit 609 determines whether the frequency of either one of the signals has changed, at Step 814. If in the affirmative, the new rotational speed of the VR target 616 is determined, at Step 816. Otherwise, the monitoring unit 609 determines whether the pulse widths have changed, at Step 818. If in the affirmative, the new axial location of the VR target 616 is determined, at Step 820. Otherwise, the pulse magnitudes are checked for changes, at Step 822. If in the affirmative, the new lateral or radial positions relative to both sensor assemblies 602a and 602b are determined, at Step 824.

The system and method, discussed above, dynamically determines axial, lateral and angular displacements of a rotating component by utilizing a longitudinally asymmetric target, which conducts a magnetic flux that can be sensed by one or more variable reluctance sensors to generate one or more response signals that may be recorded and analyzed by a monitoring unit. In an alternate embodiment, the rotating component can include a longitudinally asymmetric optical target, and the sensor assemblies include optical detectors rather than magnetic sensors. The process of determining the axial, lateral and angular displacements of the asymmetric optical target relies on the comparison of the different signals detected by the optical sensor assemblies.

It should be emphasized that the above-described embodiments of the invention, particularly, any “preferred” or “particular” embodiments, are possible examples of implementations, merely set forth for a clear understanding of the principles of the invention

Many variations and modifications may be made to the above-described embodiment(s) of the invention without substantially departing from the spirit and principles of the invention. All such modifications are intended to be included herein within the scope of this disclosure and the invention and protected by the following claims.

What is claimed is:

1. A system for dynamically determining an axial position of a rotating member, comprising:
a target component on a circumferential periphery of the rotating member, the target component having a longitudinally asymmetric shape;
a sensor assembly fixedly positioned relative to the target component, the sensor assembly detecting and outputting a plurality of signals having different pulse widths, as the target component moves axially past the sensor; and
a circuit coupled to the sensor assembly and receiving the plurality of signals, the circuit determining an axial position of the target component for each of the plurality of signals based on a comparison of the different pulse widths.

2. The system of claim 1, wherein the target component has a magnetic conducting property, and the sensor assembly has a magnetic unit and a magnetic flux detecting unit.

3. The system of claim 1, wherein the plurality of signals have different positive and negative pulse widths.

4. The system of claim 1, wherein the target component is integral to the rotating member.

5. The system of claim 1, wherein each of the plurality of signals has a frequency indicative of a rotational speed of the rotating member.

6. The system of claim 2, wherein a magnitude of each of the plurality of signals is dependent on an air gap separating the sensor assembly and the target.

7. The system of claim 2, wherein the target has includes a plurality of circumferentially interspaced slots and teeth, each of the slots having substantially non-parallel longitudinal walls.

8. The system of claim 1, wherein the circuit comprises a monitoring unit for monitor axial positions and displacements of the target relative to the sensor assembly.

9. The system of claim 1, wherein the target component is a longitudinally asymmetric optical target and the sensor assembly includes optical detectors

10. A method for dynamically determining an axial position of a rotating member via a sensor assembly, the sensor assembly fixedly positioned relative to the rotating member and having a processing circuit, the circuit having an associated memory and computer-executable instructions stored therein for performing the method, comprising the steps of:
affixing a target component to the rotating member, the target component having a longitudinally asymmetric shape;
detecting a plurality of signals as the target component moves axially past the sensor assembly, each of the plurality of signals having different pulse widths;
comparing the different pulse widths; and
determining an axial position of the target component corresponding to each of the plurality of signals based on the comparison of the different pulse widths.

11. The method of claim 10, wherein the target component has a magnetic conducting property, and the sensor assembly has a magnetic unit and a magnetic flux detecting unit.

12. The method of claim 10, wherein the plurality of signals have different positive and negative pulse widths.

13. The method of claim 10, wherein each of the plurality of signals has a frequency indicative of a rotational speed of the rotating member.

14. The method of claim 10, wherein a magnitude of each of the plurality of signals is dependent on an air gap separating the sensor assembly and the rotating member.

15. The method of claim 11, wherein the target has includes a plurality of circumferentially interspaced slots and teeth, each of the slots having substantially non-parallel longitudinal walls.

16. The method of claim 11, wherein the circuit comprises a monitoring unit for monitor axial positions and displacements of the target relative to the sensor assembly.

17. The method of claim 10, wherein the target component is a longitudinally asymmetric optical target and the sensor assembly includes optical detectors

18. A computer storage readable medium comprising instructions which when executed by a computer system causes the computer to implement a method for dynamically determining an axial position of a rotating member via a sensor assembly, the sensor assembly fixedly positioned relative to the rotating member and having a processing circuit, the method comprising the steps of:
affixing a target component to the rotating member, the target component having a longitudinally asymmetric shape;
detecting a plurality of signals as the target component moves axially past the sensor assembly, each of the plurality of signals having different pulse widths;
comparing the different pulse widths; and
determining an axial position of the target component corresponding to each of the plurality of signals based on the comparison of the different pulse widths.

19. A system for dynamically determining axial, radial and angular positions of a rotating member, comprising:
a target component on a circumferential periphery of the rotating member, the target component having a longitudinally asymmetric shape;
a plurality of sensor assemblies, each of which having corresponding fixed axial and radial positions relative to the target component, wherein each of the sensor assemblies detects and outputs a plurality of signals having different pulse widths and magnitudes, as the target component moves relative to the sensor assemblies; and
a circuit coupled to the sensor assemblies and receiving the plurality of signals outputted by each of the sensor assemblies, the circuit determining axial, radial and angular positions of the target component based on a comparison of their different pulse widths and magnitudes of the plurality of signals.

20. A method for dynamically determining axial, radial and angular positions of a rotating member, comprising the steps of:
providing a target component associated with the rotating member, the target component comprising a plurality of longitudinally asymmetric shapes;
positioning each of a plurality of sensor assemblies in proximity to the target component and around the rotating member, each of the sensor assemblies having fixed axial and radial positions relative to the target component;
detecting a modulating magnetic flux corresponding to a position of the target component as the target component moves axially and radially relative to each of the sensor assemblies, the modulating magnetic flux corresponding to a plurality of signals having different pulse widths and magnitudes;
comparing the different pulse widths and magnitudes; and
determining axial, radial and angular positions of the target component based on the comparison of the different pulse widths and magnitudes of the plurality of signals.
